(19) United States
(12) Patent Application Publication
(10) Pub. No.: US 2005/0073173 A1
(43) Pub. Date: Apr. 7, 2005

(54) Vehicle door

(75) Inventors: Maxime Belanger, Apple Valley, MN (US); Randall Gast, Chaska, MN (US)

Correspondence Address: MICHAEL BEST & FRIEDRICH LLP, 3773 CORPORATE PARKWAY, SUITE 360, CENTER VALLEY, PA, 18034-8217, US

(73) Assignee: Thermo King Corporation, Minneapolis, MN (US)

(21) Appl. No.: 10/679,758

(22) Filed: Oct. 6, 2003

(51) Int. Cl. B60J 5/12

(52) U.S. Cl. 296/155

(57) ABSTRACT

A door for use with a vehicle. The vehicle defines a load space and has an access opening communicating between the load space and atmosphere. The door includes a first panel having a first face and a lower end, and a second panel having a second face and an upper end. One of the lower end and the upper end defines a recess. Another of the lower end and the upper end has a protrusion, which is engageable in the recess to pivotably connect the first and the second panels. The second panel is pivotable relative to the first panel between a first orientation, in which the second face is substantially perpendicular to the first face, and a second orientation, in which the second face is substantially parallel to the first face. The first and second panels are removeably connected when the second panel is in the first orientation.

### FIELD OF THE INVENTION

The invention relates to vehicle doors and a method of assembling the same.

### BACKGROUND OF THE INVENTION

Trucks and tractor-trailer combinations typically have a load space, an access opening communicating between the load space and the atmosphere, and an access door positioned to cover the access opening. In addition, vehicles that transport temperature sensitive cargo generally include a temperature control unit, which maintains the air temperature of the load space within a predetermined range surrounding a set point temperature. In some constructions, access doors include a series of hingedly interconnected slats and are movable between a closed position, in which the door provides a generally vertical wall, and an opened position, in which the door is moved out of the access opening. Generally, tracks are positioned on opposite sides of the access opening to support opposite sides of the access door and to facilitate movement of the access door between the opened position and the closed position.

### SUMMARY OF THE INVENTION

Conventional access doors generally have a number of openings, cracks, and gaps, which facilitate air exchange between the load space and the atmosphere. Moreover, these openings, cracks, and gaps allow conditioned air to escape the load space and allow unconditioned atmospheric air to replace the conditioned air, thereby negatively affecting the load space air temperature. Additionally, conventional access doors generally include a number of thermally conductive fasteners which extend through holes in the doors. The holes and the fasteners that extend through the holes facilitate additional heat transfer between the load space and the atmosphere.

To address these and other concerns, the present invention provides, among other things, a door for use with a vehicle defining a load space and having an access opening communicating between the load space and atmosphere. The door includes a first panel having an end. The end has an arm and a protuberance connected to the arm. Together the end, the arm, and the protuberance define an arcuately shaped recess. The door also includes a second panel having a hook. The hook is engageable in the arcuately shaped recess to pivotably connect the first panel and the second panel. The hook has an arcuate shape corresponding to the arcuately shaped recess.

The present invention also provides a door for use with a vehicle defining a load space and having an access opening communicating between the load space and atmosphere. The door includes a first panel having a first face and a lower end. The door also comprises a second panel having a second face and an upper end. One of the lower end and the upper end defines a recess. Another of the lower end and the upper end has a protrusion which is engageable in the recess to pivotably connect the first panel and the second panel. The second panel is pivotable relative to the first panel between a first orientation, in which the second face is substantially perpendicular to the first face, and a second orientation, in which the second face is substantially parallel to the first face. The second panel is fixedly connected to the first panel when the second panel is in the second orientation and the second panel is removeably connected to the first panel when the second panel is in the first orientation.

In addition, the present invention provides a door for use with a vehicle defining a load space and having an access opening communicating between the load space and atmosphere. The door includes a first panel having an end defining an arcuately shaped recess. The door also includes a second panel having a hook. The hook is engageable in the arcuately shaped recess to pivotably connect the first panel and the second panel. The second panel and the hook are integrally formed from a thermally nonconductive material.

The present invention further provides a door panel including an elongated body having a first end and a second end. The first end has an arm and a protuberance formed at a distal end of the arm. Together the first end, the arm, and the protuberance define an arcuately shaped recess. The protuberance has a first radius and the second end has a hook having a second radius, which is less than the second radius.

The present invention also provides a method of assembling a door for a vehicle having a load space and defining an access opening communicating between the load space and atmosphere. The method includes providing a first panel having a first face and a lower end, and providing a second panel having a second face and an upper end. One of the lower end and the upper end defines a recess and another of the lower end and the upper end has a protrusion. The method also includes orienting the second panel in a first orientation, in which the second face is substantially perpendicular to the first face, inserting the protrusion into the recess, and pivoting the second panel with respect to the first panel toward a second orientation, in which the first face is substantially parallel to the second face, to matingly engage the first panel and the second panel.

The present invention further provides a method of assembling a door for a vehicle having a load space, defining an access opening communicating between the load space and atmosphere, and having tracks positioned adjacent to the access opening. The method includes inserting a first panel into the tracks, coupling a second panel to the first panel after the first panel is inserted into the tracks, and inserting the second panel into the tracks for sliding movement along the tracks with the first panel.

Other features and advantages of the invention will become apparent to those skilled in the art upon review of the following detailed description, claims, and drawings.

### BRIEF DESCRIPTION OF THE DRAWINGS

The present invention is further described with reference to the accompanying drawings, which show at least one construction of the present invention. However, it should be noted that the invention is explained and illustrated by way of example only. The various elements and combinations of elements described below and illustrated in the drawings can be arranged and organized differently to result in constructions which are still within the spirit and scope of the present invention. Also, it is understood that the phraseology and terminology used herein is for the purpose of description and should not be regarded as limiting.

In the drawings, wherein like reference numerals indicate like parts:

FIG. 1 is a perspective view, partially in section, of a vehicle having a vehicle door embodying aspects of the present invention.

FIG. 2 is a rear perspective view of the vehicle shown in FIG. 1 with the vehicle door in an open position.

FIG. 3 is a perspective view of the vehicle door shown in FIG. 1.

FIG. 4 is a sectional view of a portion of the vehicle door shown in FIG. 1.

FIG. 5 is a sectional view of a panel of the vehicle door shown in FIG. 1 taken along line V-V.

FIGS. 6A-6E illustrate a method of assembling a vehicle door.

FIG. 7 illustrates an alternate construction of a door embodying aspects of the invention.

FIG. 8 is a section view of a portion of the vehicle door shown in FIG. 7 taken along line VIII-VIII.

FIG. 9 illustrates another alternate construction of a door embodying aspects of the invention.

FIG. 10 is a section view of a portion of the vehicle door shown in FIG. 7 taken along line X-X.

FIGS. 11A-11D illustrate an alternate method of assembling a vehicle door.

### DETAILED DESCRIPTION

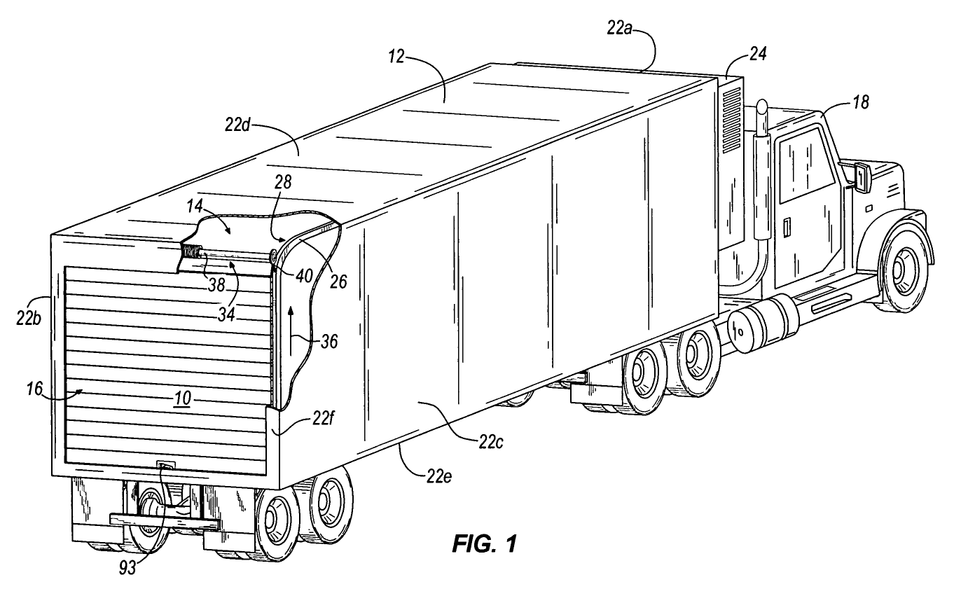

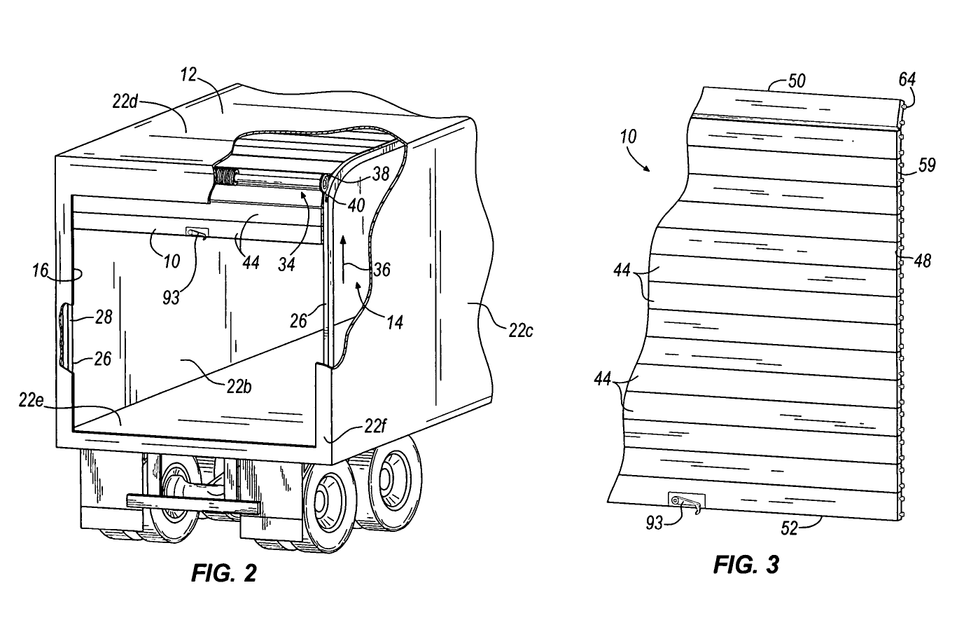

FIGS. 1-6 illustrate a door 10 in accordance with the present invention. The door 10 is especially suitable for use in transport applications and can be mounted on a container, a truck, a tractor-trailer combination, or another suitable vehicle. FIGS. 1 and 2 show the door 10 mounted on a trailer 12 having a load space 14 and defining an access opening 16 communicating between the load space 14 and the atmosphere. As is understood by those skilled in the art, a tractor 18 pulls the trailer 12.

As used herein and in the claims, the term “load space” includes any space for storing and/or transporting products or materials. Also, the terms “first”, “second”, “third”, “right”, “left”, “front”, “rear”, “forward”, “rearward”, “upper”, “lower”, “top”, and “bottom” are used herein and in the claims for description only and are not intended to imply any particular order, orientation, or importance.

As shown in FIGS. 1 and 2, the trailer 12 includes a front wall 22a, a left side wall 22b, a right side wall 22c, a top wall or ceiling 22d, and a bottom wall or floor 22e, and a rear wall 22f. Together, the walls 22a-22f substantially enclose the load space 14. A temperature control unit 24 is supported on the front wall 22a of the trailer 12 and is operable to control the load space air temperature in a known manner. In the illustrated construction, the access opening 16 extends through the rear wall 22f and communicates between the atmosphere and the load space 14 to facilitate loading and off loading of the load space 14. In other constructions (not shown), the trailer 12 can define one or more access openings 16 and the access opening(s) 16 can extend through one or more of the front wall 22a, the left side wall 22b, the right side wall 22c, the top wall 22d, the bottom wall 22e, and the rear wall 22f. Similarly, in still other constructions (not shown), the trailer 12 can provide two or more load spaces 14 and the access opening(s) 16 can communicate with one or more of the load spaces 14.

Tracks 26 extend along the left and right side walls 22b, 22c between the bottom wall 22e and the top wall 22d and define channels 28. More specifically, the tracks 26 are a pair of elongated members extending in parallel with each other. The lower portions of the tracks 26 extend in a generally vertical direction past the access opening 16 and the upper portions of the tracks 26 extend in a generally horizontal direction along the upper wall 22d. The tracks 26 support and guide the door 10 during movement between a first or opened position (shown in FIG. 2), in which the door 10 is moved away from the access opening 16, and a second or closed position (shown in FIG. 1), in which the door 10 covers the access opening 16.

As shown in FIGS. 1 and 2, the top wall 22b supports a counterbalance assembly 34, which applies an upward force (represented by arrow 36 in FIGS. 1 and 2) to the door 10. In the illustrated construction, the counterbalance assembly 34 includes a spring-loaded drum 38 and a cable 40 extending between the spring-loaded drum 38 and the upper end of the door 10. In other constructions (not shown), other conventional counterbalancing assemblies, including counterweight assemblies, pulley arrangements, and the like can also be used.

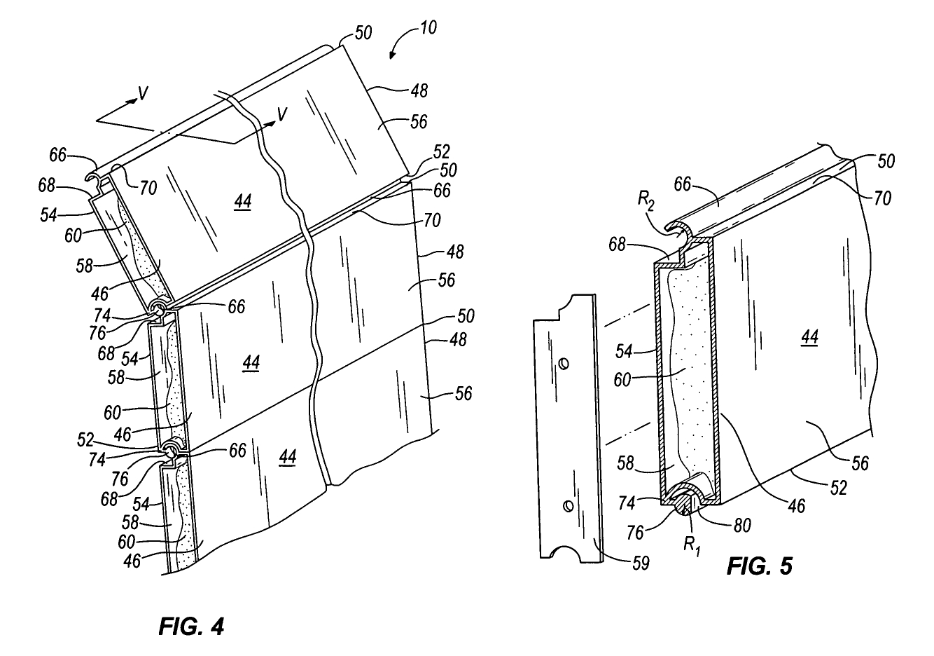

The door 10 includes a number of interconnected panels 44. As shown in FIG. 4, each of the panels 44 has a left side 46, a right side 48, an upper end 50, a lower end 52, a front face 54, and a rear face 56 that define chambers 58. As shown in FIGS. 3 and 5, end caps 59 cover the right and left sides 46, 48 and enclose the chambers 58. To provide additional insulation and to reduce heat transfer between the atmosphere and the load space 14, air can be evacuated from the chambers 58 and the chambers 58 can be sealed. Alternatively or in addition, the chambers 58 can be filled with insulation 60, such as, for example, foam, plastics, composites, and the like. In still other constructions, the panels 44 are made from a thermally nonconductive material to reduce heat transfer between the atmosphere and the load space 14. In yet another construction (not shown), each of the panels 44 can be formed as a solid piece of thermally nonconductive material without a chamber 58.

The left and right sides 46, 48 are configured to engage the tracks 26 for movement along the tracks 26 as the door 10 is moved between the first and second positions. In some constructions, the left and right sides 46, 48 support friction-reducing elements 64. In the illustrated construction, the friction reducing elements 64 are roller wheels, which engage the channels 28 and move along the tracks 26 during movement of the door 10 between the first and second positions. However, in other constructions (not shown), other friction reducing elements 64, including casters, rollers, and the like can be used.

As shown in FIGS. 4 and 5, a protrusion 66, in the shape of a hook, extends along the upper end 50 of each of the panels 44 between the left and right sides 46, 48. The protrusions 66 are generally arcuately shaped and extend upwardly from the upper ends 50 of the panels 44 before curving forwardly. The upper ends 50 also define first stops 68 and second stops 70, which are separated by the protrusions 66. As explained in greater detail below, the first and second stops 68, 70 limit pivoting movement of each of the panels 44 relative to the other panels 44.

An arm 74 extends downwardly and rearwardly from the lower end 52 of each of the panels 44. Distal ends of the arms 74 form protuberances 76. In the illustrated construction, the protuberances 76 are substantially cylindrically shaped and have a radius, which is slightly smaller than the interior radius of the protrusions 76.

Together, the arms 74, the protuberances 76, and the lower ends 52 define arcuately shaped recesses 80 (shown in FIG. 5). Each of the arcuately shaped recesses 80 is configured to matingly receive at least a portion of one of the protrusions 66 to pivotably connect the panels 44. More specifically, the radiuses of the arcuately shaped recesses 80 are slightly smaller than the exterior radiuses of the protrusions 66.

In some constructions, the panels 44 are made of a thermally nonconductive material to limit heat transfer through the door 10 between the atmosphere and the load space 14. As used herein and in the claims, the term “thermally nonconductive material” includes materials, such as, for example, plastics, composites, and the like, which generally minimize heat transfer.

In some constructions and as shown in FIGS. 4 and 5, the protrusions 66, arms 74, and the protuberances 76 of each panel 44 are integrally formed with the panel 44 from a thermally nonconductive material. Additionally, the protrusions 66 of each panel 44 are engageable in corresponding recesses 80 of the other panels 44 to connect the panels 44 and to form the door 10. In this manner, the door 10 can be assembled without conventional fasteners or with a minimal number of conventional fasteners (e.g., bolts, metal hinges, pins, and the like) which are generally formed from highly thermally conductive materials (e.g., metals).

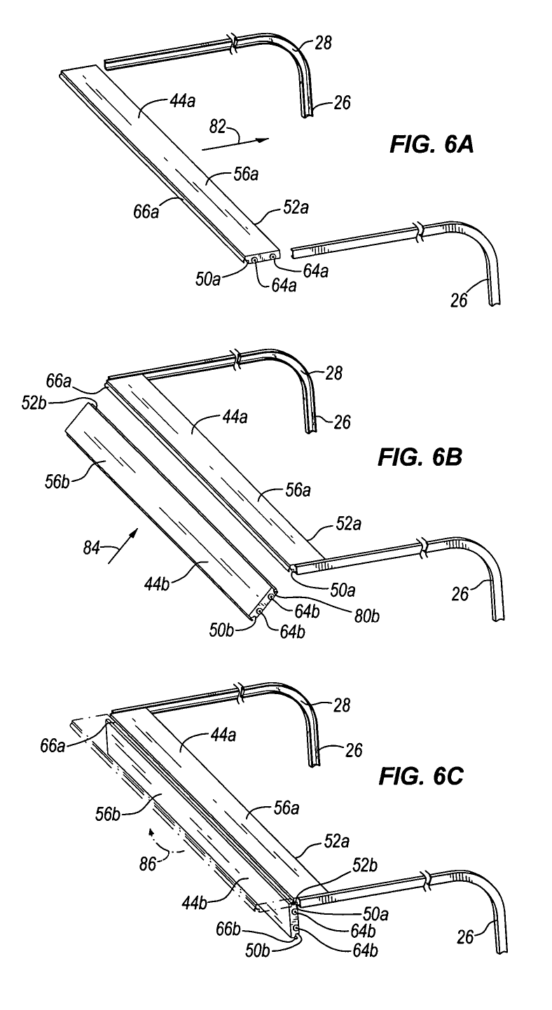

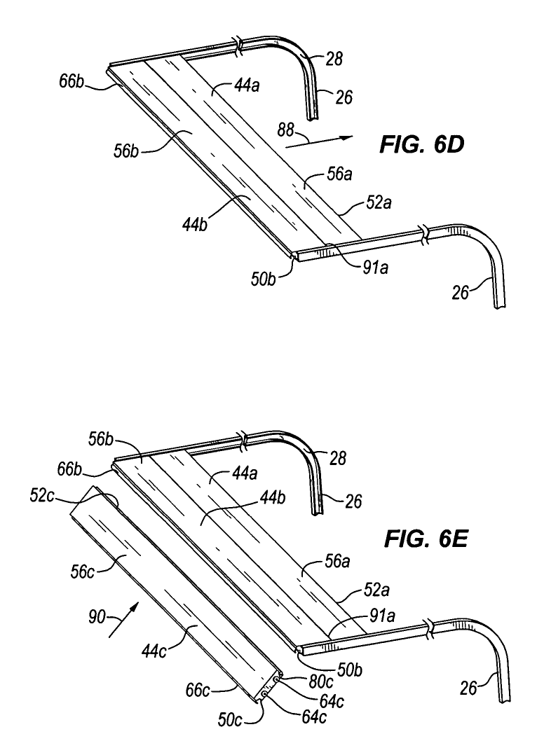

FIGS. 6A-6F illustrate a method of assembling the door 10 according to the present invention. As described hereafter and as shown in the figures, the door 10 can be assembled in-place in the trailer 12. Alternatively, the door 10 can be assembled at a second location and can then be installed in the trailer 12 as a pre-assembled unit.

In a first act and as shown in FIG. 6A, an operator aligns a first panel 44a with the tracks 26 and engages the friction-reducing elements 64a in the channels 28. As shown in the figures, the first panel 44a can be inserted into the tracks 26 from the forward or upper end of the tracks 26. Alternatively, the first panel 44a can be inserted into the tracks 26 from the lower end of the tracks 26 (not shown).

As shown in FIG. 6A and in some constructions, the first panel 44a is inserted into the tracks 26 (as represented by arrow 82 in FIG. 6D) so that the upper end 50a of the first panel 44a faces forwardly and so that the lower end 52a faces rearwardly (i.e., so that when the door 10 is in the second position, the lower end 52a faces downwardly toward the bottom wall 22e of the trailer 12 and the upper end 50a faces the upper wall 22d of the trailer 12).

In a second act, a second panel 44b is oriented in a first orientation (shown in FIG. 6B) with respect to the first panel 44a. In the first orientation, the rear face 56b of the second panel 44b is substantially perpendicular to the rear face 56a of the first panel 44a. The second panel 44b is moved upwardly toward the first panel 44a (as represented by arrow 84 in FIG. 6B) to engage the protrusion 66a of the first panel 44a in the arcuately shaped recess 80b of the second panel 44b.

After the protrusion 66a of the first panel 44a is inserted into the arcuatly shaped recess 80b of the second panel 44b, the second panel 44b is pivoted (as represented by arrow 86 in FIG. 6C) from the first orientation toward a second orientation, in which the rear face 56b of the second panel 44b is substantially parallel to the rear face 56a of the first panel 44a. The first and second panels 44a, 44b are then moved rearwardly (as represented by arrow 88 in FIG. 6D) along the tracks 26 to engage the friction reducing elements 64b (shown in FIGS. 6B and 6C) of the second panel 44b in the tracks 26.

After the friction reducing elements 64b of the second panel 44b engage the tracks 26, a third panel 44c is oriented in a first orientation (shown in FIG. 6E) with respect to the second panel 44b. In the first orientation, the rear face 56c of the third panel 44c is substantially perpendicular to the rear face 56b of the second panel 44b. The third panel 44c is moved upwardly toward the second panel 44b (as represented by arrow 90 in FIG. 6E) to engage the protrusion 56b of the second panel 44b in the arcuately shaped recess 80c of the third panel 44c. The third panel 44c is then pivoted toward a second orientation (not shown), in which the rear face 56c of the third panel 44c is substantially parallel to the rear face 56b of the second panel 44b. The first, second, and third panels 44a, 44b, 44c are then move rearwardly along the tracks 26 to engage the friction reducing elements 64c of the third panel 44c in the tracks 26. This process is then continued as necessary to form a door 10 having a number of panels 44.

The intersection of the upper end 50a of the first panel 44a and the lower end 52b of the second panel 44b defines a first air channel 91a (shown in FIGS. 6D and 6E). However, as shown in the figures, the protrusion 66a engages the protuberance 76b and the recess 80b along the length of the first and second panels 44a, 44b and prevents and/or limits the flow of air between the atmosphere and the load space 14 through the air channel 91a. In a similar manner, the engagement between other protrusions 66, protuberances 76, and recesses 80 prevents and/or limits air flow through other air channels 91 and between other panels 44.

As shown in FIG. 3, the top panel 44 of the door 10 does not include a protrusion 66 and the bottom panel 44 of the door 10 does not include an arm 74 and a protuberance 76. Rather, in the illustrated construction, the upper end 50 of the top panel 44 of the door 10 and the lower end 52 of the bottom panel 44 of the door 10 are substantially flat. In this manner, when the door 10 is in the second position, the upper end 50 of the top panel 44 and the lower end 52 of the bottom panel 44 can more closely engage the top wall 22d and the bottom wall 22e, respectively.

In some constructions and as shown in FIGS. 1-3, the bottom panel 44 includes a conventional door latching mechanism 93, which is engageable in a recess (not shown) in the bottom wall 22e to lock the door 10 in the second position. Additionally, in some constructions (not shown), the bottom panel 44 also includes a handle that can be used by an operator to move the door 10 between the first and second positions.

In the illustrated construction and as shown in FIGS. 1-5 and 6A-6E, the panels 44 are oriented so that the upper ends 50 of the panels 44 alternately face forwardly (i.e., when the door 10 is in the first position) and upwardly (i.e., when the door 10 is in the second position) and so that the lower ends 52 of the panels 44 alternately face rearwardly (i.e., when the door 10 is in the first position) and downwardly (i.e., when the door 10 is in the second position). However, in alternate constructions (not shown), the orientation of the panels 44 can be reversed. More particularly, in alternate constructions, the panels 44 are oriented so that the upper ends 50 of the panels 44 alternately face rearwardly (when the door 10 is in the first position) and downwardly (i.e., when the door 10 is in the second position) and so that the lower ends 52 of the panels 44 alternately face forwardly (i.e., when the door 10 is in the first position) and upwardly (i.e., when the door 10 is in the second position).

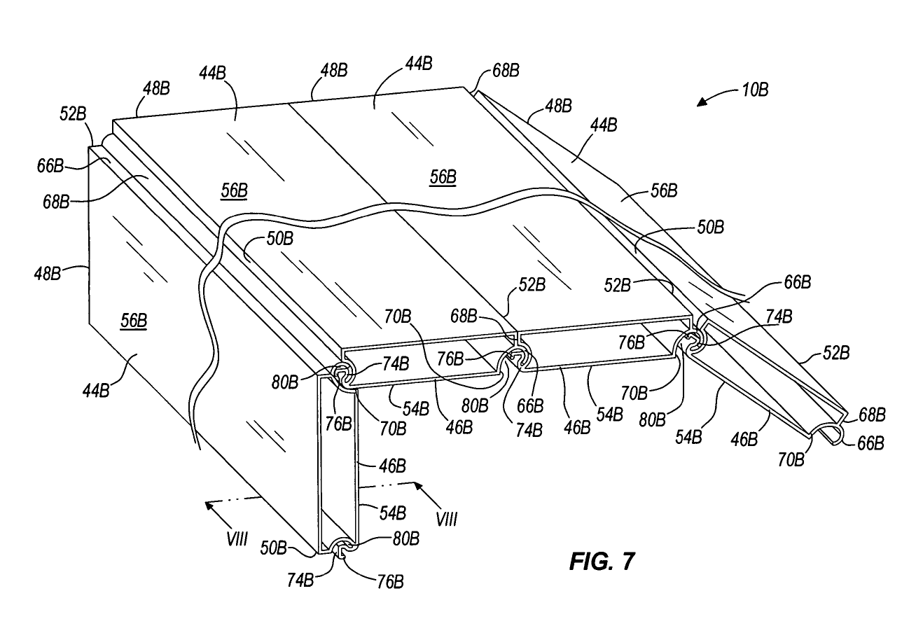

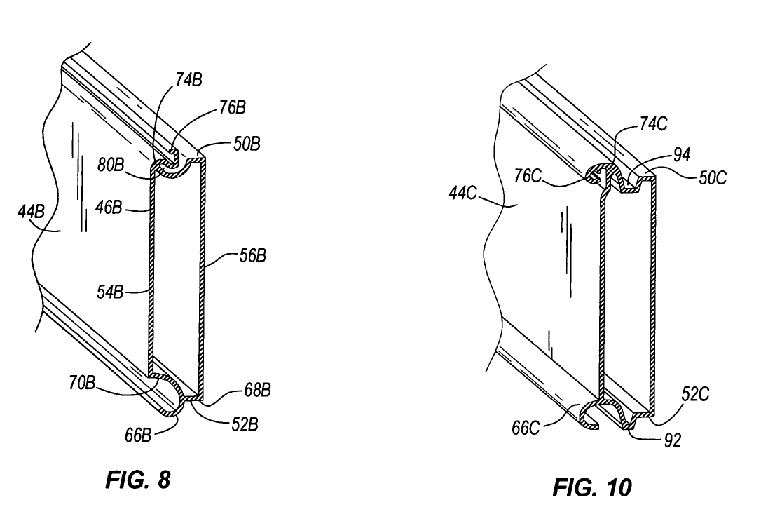

An alternate construction of the door 10B is illustrated in FIGS. 7 and 8. Common elements are identified by the same reference number “B”.

As shown in FIGS. 7 and 8, a protrusion 66B, in the shape of a hook, extends along the lower end 52B of each of the panels 44B between the left and right sides 46B, 48B and separates the first and second stops 68B, 70B. The first stops 68B are linearly shaped and are generally perpendicular to the front and rear faces 54B, 56B of the panels 44B. The second stops 70B have a generally arcuate shape.

The arms 74B extend upwardly from the upper ends 50B of the panels 44B before curving downwarly and rearwardly and then curving upwardly and forwardly. The distal ends of the arms 74B form C-shaped protuberances 76B. Together, the arms 74B, the upper ends 50B, and the protuberances 76B define arcuately shaped recesses 80B, which are configured to matingly receive at least a portion of one of the protrusions 66B to pivotably connect the panels 44B.

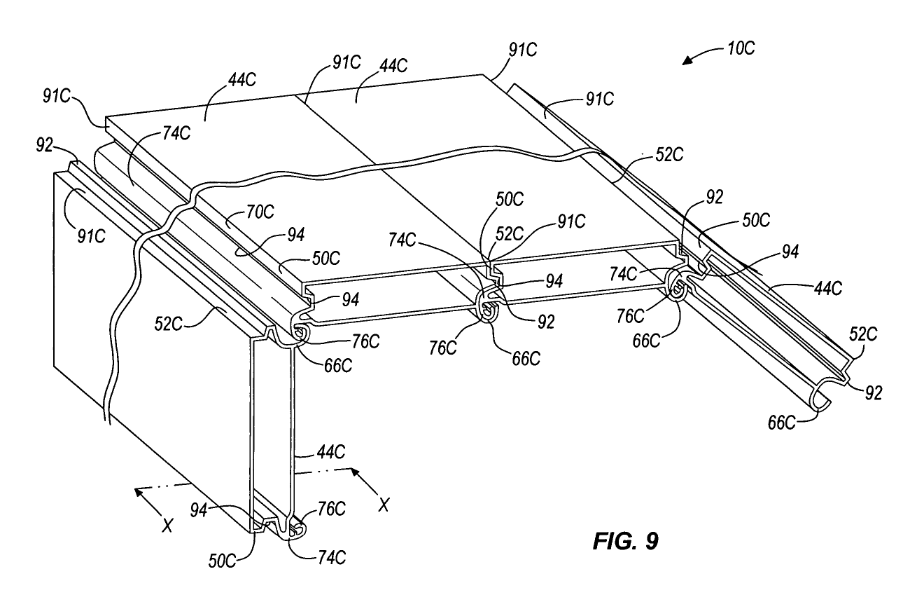

Another alternate construction of the door 10C is illustrated in FIGS. 9, 10, and 11A-11D. Common elements are identified by the same reference number “C”.

As shown in FIGS. 9, 10, and 11A-11D, protrusions 66C, in the shape of hooks, extend rearwardly from the lower ends 52C of each of the panels 44C before curving downwardly. A second protrusion or lip 92 extends downwardly from each of the lower ends 52C. Arms 74C, in the shape of hooks, extend upwardly from the upper ends 50C, curve forwardly and downwardly, and then curve rearwardly. The distal ends of the arms 74C form protuberances 76C. The protuberances 76C are engageable with the protrusions 66C of other panels 44C to matingly connect the panels 44C. The lower ends 52C also define recesses 94, which are engageable with the lips 92 to limit or prevent air flow along air channels 91C that extend between the upper end 50C of one panel 44C and the lower end 52C of another panel 44C. Also, in some constructions, the engagement between the lips 92 and the walls of the recesses 94 reduces vibration in the door 10 and reduces the loading that is applied to the protrusions 66C and the arms 74C. In still other constructions (not shown), the recesses 94 include a gasket, such as, for example, a foam strip or a gasket bulb, which further prevents air flow along the air channels 91 C, reduces vibration in the door 10, and reduces the loading applied to the protrusions 66C and the arms 74C.

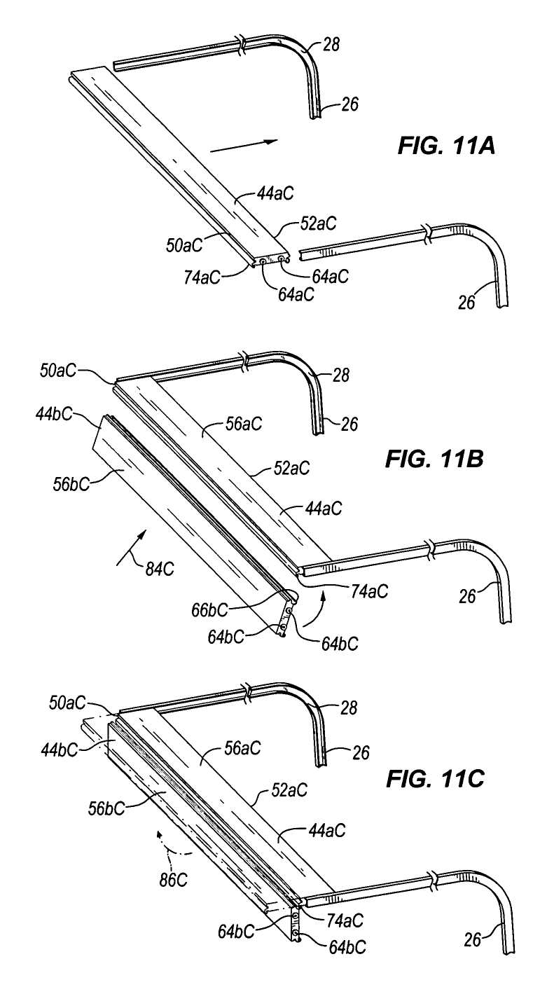

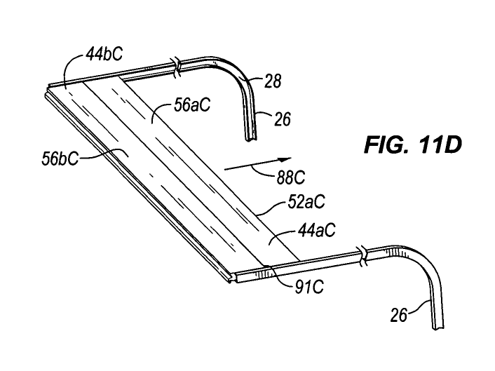

FIGS. 11A-11D illustrate a method of assembling the door 10C according to the present invention.

In a first act and as shown in FIG. 11A, an operator aligns a panel 44aC with the tracks 26 and engages the friction-reducing elements 64aC in the channels 28 so that the lower end 52aC of the first panel 44a faces rearwardly and so that the upper end 50aC faces forwardly. A second panel 44bC is oriented in a first orientation (shown in FIG. 11B) with respect to the first panel 44aC. In the first orientation, the rear face 56bC of the second panel 44bC is substantially perpendicular to the rear face 56aC of the first panel 44aC. The second panel 44bC is moved upwardly (as represented by arrow 84C in FIG. 11B) toward the first panel 44aC and the protrusion 66bC of the second panel 44bC is pivoted into engagement with the arm 74aC of the first panel 44bC. The second panel 44bC is then pivoted (as represented by arrow 86C in FIG. 11C) from the first orientation toward a second orientation (shown in phantom in FIG. 11C), in which the rear face 56bC of the second panel 44bC is substantially parallel to the rear face 56aC of the first panel 44aC. The first and second panels 44a, 44b are then moved rearwardly (as represented by arrow 88C in FIG. 11D) along the tracks 26 to engage the friction reducing elements 64b C of the second panel 44bC with the tracks 26. This process is then continued as necessary to form a door 10C having a number of panels 44C.

The constructions described above and illustrated in the drawings are presented by way of example only and are not intended to limit the concepts and principles of the present invention. As such, it will be appreciated by one having ordinary skill in the art, that various changes in the elements and their configuration and arrangement are possible without departing from the spirit and scope of the present invention as set forth in the claims.

1. A door for use with a vehicle, the vehicle defining a load space and having an access opening communicating between the load space and atmosphere, the door comprising:
a first panel having an end, the end having an arm and a protuberance connected to the arm, together the end, the arm, and the protuberance defining an arcuately shaped recess; and
a second panel having a hook, the hook being engageable in the arcuately shaped recess to pivotably connect the first panel and the second panel, the hook having an arcuate shape corresponding to the arcuately shaped recess.

2. The door of claim 1, wherein the first panel has a first face and the second panel has a second face, and wherein the second panel is pivotable relative to the first panel between a first orientation, in which the second face is substantially perpendicular to the first face, and a second orientation, in which the second face is substantially parallel to the first face.

3. The door of claim 2, wherein the second panel is fixedly connected to the first panel when the second panel is in the second orientation and wherein the second panel is removeably connected to the first panel when the second panel is in the first orientation.

4. The door of claim 2, wherein the vehicle includes tracks positioned adjacent to the access opening, and wherein the tracks limit movement of the second panel between the first orientation and the second orientation.

5. The door of claim 2, wherein one of the first panel and the second panel provides a second protuberance and an other of the first panel and the second panel defines a second recess, the second protuberance being engageable in the second recess when the second panel is in the second orientation to reduce air flow between the first panel and the second panel.

6. The door of claim 1, wherein the first panel and the second panel define an air channel between the load space and the atmosphere, the hook matingly engaging the protuberance, and together, the protuberance and the hook obstructing air flow through the air channel.

7. The door of claim 1, wherein the second panel and the hook are integrally formed from a thermally nonconductive material.

8. The door of claim 1, wherein the arm and the first panel are integrally formed from a thermally nonconductive material.

9. The door of claim 1, wherein the second panel has a second end and the hook extends along the second end, and wherein the hook engages the arcuately shaped recess along the end of the first panel.

10. A door for use with a vehicle, the vehicle defining a load space, having an access opening communicating between the load space and atmosphere, and having tracks positioned adjacent to the access opening, the door comprising:
a first panel having a first face and a lower end; and
a second panel having a second face and an upper end, one of the lower end and the upper end defining a recess, an other of the lower end and the upper end having a protrusion, the protrusion being engageable in the recess to pivotably connect the first panel and the second panel, the second panel being pivotable relative to the first panel between a first orientation, in which the second face is substantially perpendicular to the first face, and a second orientation, in which the second face is substantially parallel to the first face, the second panel being fixedly connected to the first panel when the second panel is in the second orientation and the second panel being removeably connected to the first panel when the second panel is in the first orientation;
wherein the second panel is moveable between the first orientation and the second orientation when the first panel is supported in the tracks.

11. The door of claim 10, and wherein the tracks limit movement of the second panel between the first orientation and the second orientation.

12. The door of claim 10, wherein the protrusion is a hook, and wherein the one of the lower end and the upper end includes an arm and a protuberance connected to the arm, together the end, the arm, and the protuberance defining the recess.

13. The door of claim 10, wherein one of the first panel and the second panel and the protrusion are integrally formed from a thermally nonconductive material.

14. The door of claim 10, wherein the first panel provides a second protrusion and the second panel defines a second recess, the second protrusion being engageable in the second recess when the second panel is in the second orientation to reduce air flow between the first panel and the second panel.

15. The door of claim 10, wherein the recess extends along the one of the lower end and the upper end, and wherein the protrusion extends along the other of the lower end and the upper end.

16. A door for use with a vehicle, the vehicle defining a load space and having an access opening communicating between the load space and atmosphere, the door comprising:
a first panel having an end, the end having an arm, together the end and the arm defining an arcuately shaped recess; and
a second panel having a hook, the hook being engageable in the arcuately shaped recess to pivotably connect the first panel and the second panel, the second panel and the hook being integrally formed from a thermally nonconductive material.

17. The door of claim 16, wherein the end includes an arm and a protuberance connected to the arm, together the end, the arm, and the protuberance defining the arcuately shaped recess.

18. The door of claim 16, wherein the first panel has a first face and the second panel has a second face, and wherein the second panel is pivotable relative to the first panel between a first orientation, in which the second face is substantially perpendicular to the first face, and a second orientation, in which the second face is substantially parallel to the first face.

19. The door of claim 18, wherein the second panel is fixedly connected to the first panel when the second panel is in the second orientation and wherein the second panel is removeably connected to the first panel when the second panel is in the first orientation.

20. The door of claim 18, wherein the vehicle includes tracks positioned adjacent to the access opening, and wherein the tracks limit movement of the second panel between the first orientation and the second orientation.

21. The door of claim 18, wherein one of the first panel and the second panel provides a protuberance and an other of the first panel and the second panel defines a second recess, the protuberance being engageable in the second recess when the second panel is in the second orientation to reduce air flow between the first panel and the second panel.

22. The door of claim 16, wherein the second panel has a second end and the hook extends along the second end, and wherein the arcuately shaped recess extends along the end of the first panel.

23. A door panel comprising an elongated body having a first end and a second end, the first end having an arm and a protuberance formed at a distal end of the arm, together the first end, the arm, and the protuberance defining an arcuately shaped recess, the protuberance having a first radius, the second end having a hook, the hook having a second radius, the second radius being greater than the first radius.

24. The door panel of claim 23, wherein the panel has a first face, and wherein the arm and the protuberance are configured to pivotably engage a second panel having a second face, the first panel being pivotable relative to the second panel between a first orientation, in which the first face is substantially perpendicular to the second face, and a second orientation, in which the first face is substantially parallel to the second face.

25. The door panel of claim 24, wherein the first panel is removably connectable with the second panel when the first panel is in the first orientation.

26. The door panel of claim 24, wherein the second panel is non-removably connectable with the second panel when the first panel is in the second orientation.

27. The door panel of claim 23, wherein the elongated body and one of the arm and the hook are integrally formed from a thermally nonconductive material.

28. A method of assembling a door for a vehicle, the vehicle having a load space and defining an access opening communicating between the load space and atmosphere, and having tracks positioned adjacent to the access opening, the method comprising:
providing a first panel having a first face and a lower end;
inserting the first panel into the tracks,
providing a second panel having a second face and an upper end, one of the lower end and the upper end defining a recess, an other of the lower end and the upper end having a protrusion,
orienting the second panel in a first orientation, in which the second face is substantially perpendicular to the first face, and inserting the protrusion into the recess; and
pivoting the second panel with respect to the first panel toward a second orientation, in which the first face is substantially parallel to the second face, to matingly engage the first panel and the second panel after the first panel is inserted into the tracks.

29. The method of claim 28, wherein the method includes inserting the first panel in the tracks before inserting the protrusion into the recess.

30. The method of claim 28, wherein the method includes inserting the first panel in the tracks and moving the first panel along the tracks in a first direction, and wherein inserting the protrusion into the recess includes moving the second panel in a second direction, the second direction being substantially perpendicular to the first direction.

31. The method of claim 28, wherein orienting the second panel in the first orientation, in which the second face is substantially perpendicular to the first face, and inserting the protrusion into the recess includes removably connecting the first panel and the second panel.

32. A method of assembling a door for a vehicle, the vehicle having a load space, defining an access opening communicating between the load space and atmosphere, and having tracks positioned adjacent to the access opening, the method comprising:
inserting a first panel into the tracks;
coupling a second panel to the first panel after the first panel is inserted into the tracks; and
inserting the second panel into the tracks for sliding movement along the tracks with the first panel.

33. The method of claim 32, wherein the first panel has a first face the second panel has a second face, and wherein coupling the second panel to the first panel after the first panel is inserted into the tracks includes orienting the second panel in an orientation, in which the second face is substantially perpendicular to the first face, and removably connecting the first panel and the second panel.

34. The method of claim 33, wherein coupling the second panel to the first panel after the first panel is inserted into the tracks includes pivoting the second panel with respect to the first panel toward a second orientation, in which the first face is substantially parallel to the second face, and non-removably connecting the first panel and the second panel.
